(19) United States
(12) Patent Application Publication
(10) Pub. No.: US 2022/0049091 A1
(43) Pub. Date: Feb. 17, 2022

(54) HIGH WELD LINE STRENGTH POLYPROPYLENE/POLYCARBONATE ALLOY AND PREPARATION METHOD THEREOF

(71) Applicant: KINGFA SCI. & TECH. CO., LTD., Guangdong (CN)

(72) Inventors: Yan YANG, Guangdong (CN); Mingkun LI, Guangdong (CN); Xianbo HUANG, Guangdong (CN); Nanbiao YE, Guangdong (CN); Wei TONG, Guangdong (CN); Xiangmao DONG, Guangdong (CN); Junwei AI, Guangdong (CN)

(73) Assignee: KINGFA SCI. & TECH. CO., LTD., Guangdong (CN)

(21) Appl. No.: 17/293,489

(22) PCT Filed: Oct. 30, 2019
(86) PCT No.: PCT/CN2019/114379

§ 371 Date: May 13, 2021

(30) Foreign Application Priority Data
Nov. 13, 2018 (CN) 201811348964.X

(51) Int. Cl. C08L 69/00

(52) U.S. Cl. CPC C08L 69/00; C08L 2205/025; C08L 2205/06; C08L 2205/08; C08L 2205/03

(57) ABSTRACT

The present invention discloses a high weld line strength polypropylene/polycarbonate alloy, including the following components in parts by weight: 5 parts to 40 parts of a polypropylene; 40 parts to 85 parts of a polycarbonate; and 1 part to 15 parts of an ethylene copolymer compatibilizer. The high weld line strength polypropylene/polycarbonate alloy has high weld line strength, a good melt index and an excellent chemical resistance.

### BACKGROUND

### Technical Field

The present invention relates to the technical field of polymer materials, and more particularly, relates to a high weld line strength polypropylene/polycarbonate alloy and a preparation method thereof.

Polycarbonate (PC) is an engineering plastic with excellent performances, having an excellent mechanical property and an excellent dimensional stability, and a thermal stability, a weather resistance, a creep resistance, and a heat resistance are good. However, due to the presence of a rigid group in the PC molecular chain, a melt viscosity thereof is high, and in addition, its product has a poor chemical resistance.

By blending a polypropylene with the polycarbonate, flowability of the polycarbonate can be improved, and thus processability can be improved, and a material having good processability and an excellent chemical resistance can be obtained. However, due to its poor compatibility, low weld line strength, and insufficient chemical resistance, the alloy becomes a weak point, which can easily lead to fracture failure of a part.

### SUMMARY

An objective of the present invention is to overcome the above technical defects, and to provide a high weld line strength polypropylene/polycarbonate alloy, having an excellent chemical resistance.

Another objective of the present invention is to provide a preparation method of the above-mentioned polypropylene/polycarbonate alloy.

The present invention is realized by the following technical solution.

A high weld line strength polypropylene/polycarbonate alloy includes the following components in parts by weight: 5 parts to 40 parts of a polypropylene, 40 parts to 85 parts of a polycarbonate, and 1 part to 15 parts of an ethylene copolymer compatibilizer.

The polypropylene is selected from at least one of a copolymerized polypropylene and a homopolymerized polypropylene.

The ethylene copolymer compatibilizer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer. The ethylene copolymer of acrylic acid is selected from at least one of an ethylene-methacrylic acid copolymer, an ethylene-ethyl acrylate copolymer, and an ethylene-butyl acrylate copolymer. Preferably, the ethylene copolymer compatibilizer is selected from the ethylene copolymer of acrylic acid.

Preferably, the ethylene copolymer compatibilizer is selected from an ethylene copolymer compatibilizer containing a reactive active group, wherein the ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer. The reactive active group is at least one of a maleic anhydride group and an epoxy group, and a grafting ratio of the reactive active group is 0.1% to 15%. The ethylene copolymer of acrylic acid is selected from at least one of an ethylene-methacrylic acid copolymer, an ethylene-ethyl acrylate copolymer, and an ethylene-butyl acrylate copolymer. Preferably, the ethylene copolymer is selected from the ethylene copolymer of acrylic acid.

The polycarbonate is selected from an aromatic polycarbonate, an aliphatic polycarbonate, and an aromatic-aliphatic polycarbonate. Preferably, the polycarbonate has a weight average molecular weight of 18,000 to 28,000.

In parts by weight, 0 part to 10 parts of a processing aid and/or an additive are further included.

Further, by selecting the polypropylene and the ethylene copolymer compatibilizer, weld line strength of the present invention is further improved.

After melt mixing the polycarbonate and the polypropylene into an alloy, a phase structure with the polypropylene as a dispersed phase and the polycarbonate as a continuous phase is formed. The weld line strength is determined jointly by a particle size and an orientation of the dispersed phase at a weld line as well as a surface tension between the polycarbonate and the polypropylene. The smaller the particle size of the dispersed phase, the smaller the orientation, and the smaller the surface tension, the higher the weld line strength is. The particle size can be known from a formula that, when a melt index of the dispersed phase is large, EEK is small, which is easier to reduce the particle size of the dispersed phase; however, according to a diffusion theory of a polymer, the large melt index of the dispersed phase will lead to an increase of the orientation, and therefore, a selection of the melt index of the dispersed phase needs to selected to balance the particle size and the orientation, and only when the particle size is reduced to a maximum extent while maintaining the relatively small orientation, the high weld line strength can be obtained.

$$d ≅ \frac{24 {P}_{r} γ}{π {σ}_{12}} ( φ + \frac{4 {P}_{r} {E}_{DK}}{π {σ}_{12}} {φ}^{2} )$$

ϕ: a volume fraction of the dispersed phase; Pᵣ: a probability of collision; γ: an interfacial bonding force; σ₁₂: a shear stress.

Furthermore, a general ethylene copolymer compatibilizer is a B-D type graft copolymer, wherein a B chain segment of an ethylene molecular chain segment is similar in structure to the polypropylene, and has an excellent compatibility with the polypropylene due to the similar compatibility; in addition, there is a chemical reaction between a D chain segment and an end group of the polycarbonate, and the D segment chain is combined with the polycarbonate through a chemical bond, so that a compatibility with the polycarbonate is correspondingly improved, that is to say, the compatibilizer is used as a bridging substance to connect the polypropylene and the polycarbonate, thereby improving a compatibility between the polypropylene and the polycarbonate, and thus reducing the surface tension. Therefore, after the ethylene copolymer compatibilizer is added to an alloy of a polypropylene resin and a polycarbonate resin, the particle size of the dispersed phase is thereby indirectly reduced. However, due to an increase in the compatibility, an interaction force between molecular chains is also increased, thereby reducing a melt index of the alloy system.

A melt index of the ethylene copolymer compatibilizer affects a degree and a rate of diffusion. When the melt index is too low, the ethylene copolymer compatibilizer diffuses slowly in a molten state, so that it cannot play a role of increasing the compatibility. When the melt index reaches a certain level, the ethylene copolymer compatibilizer easily diffuses to an interface between the dispersed phase and the continuous phase, and connects the dispersed phase and the continuous phase of the alloy, thereby increasing the interfacial bonding force, and through a stress transfer, reducing the particle size of the dispersed phase and improving the weld line strength of the alloy. However, when the melt index of the ethylene copolymer compatibilizer is too high, a degree of interpenetration of the ethylene copolymer compatibilizer between the dispersed phase and the continuous phase is instead reduced, and the weld line strength is instead reduced.

A number and a type of an active group of the ethylene copolymer compatibilizer affect reactivity with the polycarbonate, and the reactive active group increases a degree of reaction with the polycarbonate, and thus the weld line strength is improved and the melt index of the alloy is decreased due to an increase in a steric hindrance and an intermolecular force.

In summary, according to the present invention, by increasing the melt index of the polypropylene within a melt index range of 40 g/10 min to 150 g/10 min under a test condition of 230° C., 2.16 kg, the particle size is reduced to a maximum extent while maintaining the relatively small orientation, and an ethylene copolymer compatibilizer is selected to indirectly reduce the particle size of the dispersed phase. Such, in the polypropylene/polycarbonate alloy of the present invention, the particle size of the dispersed phase is small and the orientation is also small, and as a result, the weld line strength of the polycarbonate alloy is improved.

An ethylene copolymer of acrylic acid has a good solvent resistance and is resistant to most chemicals. Furthermore, due to its relatively high melt strength and similar compatibility of its polar group with the polycarbonate, weld line strength of a polycarbonate alloy thus can be significantly improved.

The high weld line strength polypropylene/polycarbonate alloy of the present invention has weld line strength of 60% or more and a melt index of 10 g/10 min or more, and a weld line strength test is according to ASTM D638 standard test, where a test condition of the melt index is 260° C., 2.16 kg. More preferably, the high weld line strength polypropylene/polycarbonate alloy has the weld line strength of 65% or more and the melt index of 10 g/10 min or more, and the weld line strength test is according to the ASTM D638 standard test, where the test condition of the melt index is 260° C., 2.16 kg.

A preparation method of the high weld line strength polypropylene/polycarbonate alloy includes the following steps: mixing the polycarbonate, the polypropylene, the ethylene copolymer compatibilizer, and the processing aid and/or the additive evenly according to a ratio in a high-speed mixer; then adding into a twin-screw extruder, melt mixing at a temperature of 220° C. to 240° C., and then granulating, cooling and drying to obtain a high weld line strength polycarbonate alloy.

In order to obtain the high weld strength polypropylene/polycarbonate alloy having the weld strength of 60% or more and the melt index of 10 g/10 min or more, the polypropylene has the melt index of greater than 40 g/10 min to 150 g/10 min under the test condition of 230° C., 2.16 kg. Preferably, the polypropylene has the melt index of greater than 60 g/10 min to 150 g/10 min under the test condition of 230° C., 2.16 kg.

The ethylene copolymer compatibilizer has a melt index of 0.2 g/10 min to 50 g/10 min under a test condition of 190° C., 2.16 kg. Preferably, the ethylene copolymer compatibilizer has the melt index of greater than or equal to 0.4 g/10 min to 35 g/10 min under the test condition of 190° C., 2.16 kg.

The present invention has the following beneficial effects.

According to the present invention, by adding the ethylene copolymer compatibilizer to a polypropylene/polycarbonate alloy, weld line strength and chemical resistance of the alloy are improved. Further, the present invention discovers that the ethylene copolymer of acrylic acid greatly improves the weld line strength and chemical resistance strength of the alloy. Furthermore, the present invention optimizes the melt indexes of the polypropylene and the ethylene copolymer compatibilizer, and the weld line strength of the resulting alloy is further improved. The present invention also discovers that a weight average molecular weight of the polycarbonate also affects the weld line strength and the chemical resistance of the alloy, that is, when the weight average molecular weight of the polycarbonate is 18,000 to 28,000, the alloy has better weld line strength and chemical resistance. In summary, the high weld line strength polypropylene/polycarbonate alloy of the present invention has the advantages of high weld line strength, an excellent chemical resistance, and the like.

### DESCRIPTION OF THE EMBODIMENTS

The present invention will be further illustrated below by specific implementations, the following embodiments are preferred implementations of the invention, but the implementations of the present invention are not limited by the following embodiments.

Raw materials of Embodiments and Comparative Examples are commercially available, specifically:

polypropylene: copolymerized polypropylene;

EMA: ethylene-methacrylic acid copolymer;

EEA: ethylene-ethyl acrylate copolymer;

EMA-g-GMA: ethylene-methacrylic acid graft epoxy group (GMA is an epoxy group);

EVA: ethylene-vinyl acetate copolymer;

SEBS: styrene-ethylene-butadiene-styrene copolymer;

compatibilizer B: PP-G-MAH (polypropylene graft maleic anhydride);

polycarbonate A: an aromatic polycarbonate with a weight average molecular weight being 28,000;

polycarbonate B: an aliphatic polycarbonate with a weight average molecular weight being 18,000;

polycarbonate C: an aromatic polycarbonate with a weight average molecular weight being 8,000;

polycarbonate D: an aromatic polycarbonate with a weight average molecular weight being 30,000;

anti-aging agent: anti-oxidant:anti-ultraviolet aging agent=1:1.

A preparation method of a polycarbonate alloy in Embodiments and Comparative Examples: A preparation method of a polypropylene/polycarbonate alloy in Embodiments and Comparative Examples: a polycarbonate, a polypropylene, a compatibilizer, and a processing aid and/or an additive were mixed evenly according to a ratio in a high-speed mixer; then added into a twin-screw extruder, melt mixed at a temperature of 220° C. to 240° C., and then granulated, cooled and dried to obtain a high weld line strength polycarbonate alloy.

Each Test Method:

(1) Alloy Melt Index (MFR): according to a test ASTM D1238, a test condition of the polycarbonate alloy is 260° C., 2.16 kg;

(2) Chemical resistance: a sample is immersed in various chemicals (methanol, 10% sulfuric acid, thinning solvent, acetone, soybean oil, and ink) for 7 days and visually observed to evaluate the chemical resistance. There are four grades: completely no changes in appearance marked as excellent, a slight swelling marked as good, a micro number of cracks marked as medium, and a large number of cracks or fractures marked as poor.

(3) Weld line strength: characterized by a weld line coefficient Flu:

F_{KL}=TS_{X}/TS₀×100%

TS_{X} is tensile strength of weld line and TS₀ is tensile strength without the weld line, and an ASTM D638 standard test is applied.

TABLE 1
Ingredients and ratios (in parts by weight) and
each performance test results of Embodiments 1 to 10

| | | Embodi- | Embodi- | Embodi- | Embodi- | Embodi- |
|---|---|---|---|---|---|---|
| | | ment | ment | ment | ment | ment |
| | | 1 | 2 | 3 | 4 | 5 |
| Polypropylene | MFR, | 40 | 40 | 40 | 40 | 40 |
| | g/10 min | | | | | |
| | Amount, | 15 | 15 | 15 | 15 | 15 |
| | parts | | | | | |
| Polycarbonate A, parts | | 80 | 80 | 80 | 80 | 80 |
| Compatibilizer | Species of | — | — | — | — | — |
| A | reactive | | | | | |
| | active | | | | | |
| | group | | | | | |
| | Grafting | — | — | — | — | — |
| | rate of | | | | | |
| | reactive | | | | | |
| | active | | | | | |
| | group, % | | | | | |
| | Ethylene | EMA | EMA | EMA | EMA | EMA |
| | copolymer | | | | | |
| | MFR, | 0.2 | 0.4 | 5 | 10 | 15 |
| | g/10 min | | | | | |
| | Amount, | 5 | 5 | 5 | 5 | 5 |
| | parts | | | | | |
| Anti-aging agent | | 0.5 | 0.5 | 0.5 | 0.5 | 0.5 |
| MFR, g/10 min | | 12 | 13 | 16 | 23 | 27 |
| Weld line strength, % | | 65 | 70 | 75 | 80 | 85 |
| Chemical resistance | | excellent | excellent | excellent | excellent | excellent |
| | | Embodi- | Embodi- | Embodi- | Embodi- | Embodi- |
| | | ment | ment | ment | ment | ment |
| | | 6 | 7 | 8 | 9 | 10 |
| Polypropylene | MFR, | 40 | 40 | 60 | 80 | 100 |
| | g/10 min | | | | | |
| | Amount, | 15 | 15 | 15 | 15 | 15 |
| | parts | | | | | |
| Polycarbonate A, parts | | 80 | 80 | 80 | 80 | 80 |
| Compatibilizer | Species of | — | — | — | — | — |
| A | reactive | | | | | |
| | active | | | | | |
| | group | | | | | |
| | Grafting | — | — | — | — | — |
| | rate of | | | | | |
| | reactive | | | | | |
| | active | | | | | |
| | group, % | | | | | |
| | Ethylene | EMA | EMA | EMA | EMA | EMA |
| | copolymer | | | | | |
| | MFR, | 35 | 50 | 5 | 5 | 5 |
| | g/10 min | | | | | |
| | Amount, | 5 | 5 | 5 | 5 | 5 |
| | parts | | | | | |

| | | | | | |
|---|---|---|---|---|---|
| Anti-aging agent | 0.5 | 0.5 | 0.5 | 0.5 | 0.5 |
| MFR, g/10 min | 30 | 36 | 18 | 22 | 25 |
| Weld line strength, % | 81 | 68 | 80 | 83 | 85 |
| Chemical resistance | excellent | excellent | excellent | excellent | excellent |

TABLE 2
Ingredients and ratios (in parts by weight) and
each performance test results of Embodiments 11 to 20

| | | Embodi- | Embodi- | Embodi- | Embodi- | Embodi- |
|---|---|---|---|---|---|---|
| | | ment | ment | ment | ment | ment |
| | | 11 | 12 | 13 | 14 | 15 |
| Polypropylene | MFR, | 150 | 40 | 40 | 40 | 100 |
| | g/10 min | | | | | |
| | Amount, | 15 | 15 | 15 | 15 | 15 |
| | parts | | | | | |
| Polycarbonate A, parts | | 80 | 80 | 80 | 80 | 80 |
| Polycarbonate B, parts | | — | — | — | — | — |
| Polycarbonate C, parts | | — | — | — | — | — |
| Polycarbonate D, parts | | — | — | — | — | — |
| Compatibilizer | Species of | — | — | — | — | GMA |
| A | reactive | | | | | |
| | active | | | | | |
| | group | | | | | |
| | Grafting | — | — | — | — | 0.1 |
| | rate of | | | | | |
| | reactive | | | | | |
| | active | | | | | |
| | group, % | | | | | |
| | Ethylene | EMA | EEA | EVA | SEBS | EMA |
| | copolymer | | | | | |
| | MFR, | 5 | 0.2 | 0.2 | 0.2 | 5 |
| | g/10 min | | | | | |
| | Amount, | 5 | 5 | 5 | 5 | 5 |
| | parts | | | | | |
| Anti-aging agent | | 0.5 | 0.5 | 0.5 | 0.5 | 0.5 |
| MFR, g/10 min | | 38 | 13 | 11 | 12 | 22 |
| Weld line strength, % | | 89 | 66 | 61 | 60 | 87 |
| Chemical resistance | | excellent | excellent | excellent | excellent | excellent |
| | | Embodi- | Embodi- | Embodi- | Embodi- | Embodi- |
| | | ment | ment | ment | ment | ment |
| | | 16 | 17 | 18 | 19 | 20 |
| Polypropylene | MFR, | 100 | 100 | 100 | 100 | 100 |
| | g/10 min | | | | | |
| | Amount, | 15 | 15 | 15 | 15 | 15 |
| | parts | | | | | |
| Polycarbonate A, parts | | 80 | 80 | — | — | — |
| Polycarbonate B, parts | | — | — | 80 | — | — |
| Polycarbonate C, parts | | — | — | — | 80 | — |
| Polycarbonate D, parts | | — | — | — | — | 80 |
| Compatibilizer | Species of | GMA | GMA | — | — | — |
| A | reactive | | | | | |
| | active | | | | | |
| | group | | | | | |
| | Grafting | 5 | 15 | — | — | — |
| | rate of | | | | | |
| | reactive | | | | | |
| | active | | | | | |
| | group, % | | | | | |
| | Ethylene | EMA | EMA | EMA | EMA | EMA |
| | copolymer | | | | | |
| | MFR, | 5 | 5 | 5 | 5 | 5 |
| | g/10 min | | | | | |
| | Amount, | 5 | 5 | 5 | 5 | 5 |
| | parts | | | | | |

| | | | | | |
|---|---|---|---|---|---|
| Anti-aging agent | 0.5 | 0.5 | 0.5 | 0.5 | 0.5 |
| MFR, g/10 min | 18 | 14 | 31 | 34 | 21 |
| Weld line strength, % | 89 | 91 | 85 | 74 | 65 |
| Chemical resistance | excellent | excellent | excellent | excellent | excellent |

TABLE 3
Ingredients and ratios (in parts by weight) and each performance
test results of Embodiments 21 to 22 and Comparative Examples

| | | Embodi- | Embodi- | Comparative | Comparative | Comparative | Comparative |
|---|---|---|---|---|---|---|---|
| | | ment | ment | Example | Example | Example | Example |
| | | 21 | 22 | 1 | 2 | 3 | 4 |
| Polypropylene | MFR, | 100 | 100 | 100 | 100 | 30 | 40 |
| | g/10 min | | | | | | |
| | Amount, | 15 | 15 | 15 | 15 | 15 | 15 |
| | parts | | | | | | |
| Polycarbonate A, | | 80 | 80 | 80 | 80 | 80 | 80 |
| parts | | | | | | | |
| Compatibilizer | Species | — | — | — | — | — | — |
| A | of | | | | | | |
| | reactive | | | | | | |
| | active | | | | | | |
| | group | | | | | | |
| | Grafting | — | — | — | — | — | — |
| | rate of | | | | | | |
| | reactive | | | | | | |
| | active | | | | | | |
| | group, % | | | | | | |
| | Ethylene | EMA | EMA | — | — | EMA | EMA |
| | copolymer | | | | | | |
| | MFR, | 5 | 5 | — | — | 5 | 60 |
| | g/10 min | | | | | | |
| | Amount, | 1 | 15 | — | — | 5 | 5 |
| | parts | | | | | | |

| | | | | | | |
|---|---|---|---|---|---|---|
| Amount of | — | — | — | 5 | — | — |
| compatibilizer B, | | | | | | |
| parts | | | | | | |
| Anti-aging agent | 0.5 | 0.5 | 0.5 | 0.5 | 0.5 | 0.5 |
| MFR, g/10 min | 12 | 28 | 20 | 30 | 11 | 40 |
| Weld line | 77 | 89 | 10 | 25 | 53 | 57 |
| strength, % | | | | | | |
| Chemical resistance | excellent | excellent | poor | good | good | good |

It can be seen from Embodiments 1 to 7 and Comparative Example 4 that as an increase of the melt index of the ethylene copolymer compatibilizer, the melt index of the product increases and the weld line strength is in an inverted U-shape; when the melt index of the ethylene copolymer compatibilizer is 0.4 g/10 min to 35 g/10 min (under a test condition of 190° C., 2.16 kg), the weld line strength of the product is relatively high; when the melt index of the ethylene copolymer compatibilizer is 60 g/10 min (under the test condition of 190° C., 2.16 kg), the weld line strength and the chemical resistance of the product are greatly reduced.

It can be seen from Embodiments 3, 8 to 11 that as an increase of the melt index of the polyolefin, the weld line strength and the melt index of the product are increased.

It can be seen from Embodiment 10 and Embodiments 15 to 17 that the ethylene copolymer compatibilizer containing reactive active groups is more capable of increasing the weld line strength compared with the ethylene copolymer compatibilizer containing no reactive active groups.

It can be seen from Embodiments 1, 12, 13, 14 that when the ethylene copolymer of acrylic acid is as a compatibilizer, each performance of the product is relatively good.

It can be seen from Embodiment 3 and Comparative Example 3 that when the melt index of the polyolefin is 30 g/10 min (under the test condition of 230° C., 2.16 kg), the weld line strength of the product is considerably decreased and the melt index is relatively low.

It can be seen from Embodiments 10, 18 to 20 that the product prepared by a polycarbonate with a weight average molecular weight being 18,000 to 28,000 has relatively high weld line strength.

1. A high weld line strength polypropylene/polycarbonate alloy, comprising the following components in parts by weight: 5 parts to 40 parts of a polypropylene, 40 parts to 85 parts of a polycarbonate, and 1 part to 15 parts of an ethylene copolymer compatibilizer.

2. The high weld line strength polypropylene/polycarbonate alloy according to claim 1, wherein the polypropylene is selected from at least one of a copolymerized polypropylene and a homopolymerized polypropylene.

3. The high weld line strength polypropylene/polycarbonate alloy according to claim 1, wherein the ethylene copolymer compatibilizer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer; the ethylene copolymer of acrylic acid is selected from at least one of an ethylene-methacrylic acid copolymer, an ethylene-ethyl acrylate copolymer, and an ethylene-butyl acrylate copolymer.

4. The high weld line strength polypropylene/polycarbonate alloy according to claim 3, wherein the ethylene copolymer compatibilizer is selected from the ethylene copolymer of acrylic acid.

5. The high weld line strength polypropylene/polycarbonate alloy according to claim 1, wherein the ethylene copolymer compatibilizer is selected from an ethylene copolymer compatibilizer containing a reactive active group, wherein an ethylene copolymer is selected from at least one of an ethylene copolymer of acrylic acid, an ethylene-vinyl acetate copolymer, a styrene-butadiene-styrene copolymer, a styrene-ethylene-butadiene-styrene copolymer, and a styrene-ethylene-propylene-styrene copolymer, the reactive active group is at least one of a maleic anhydride group and an epoxy group, and a grafting ratio of the reactive active group is 0.1% to 15%; and the ethylene copolymer of acrylic acid is selected from at least one of an ethylene-methacrylic acid copolymer, an ethylene-ethyl acrylate copolymer, and an ethylene-butyl acrylate copolymer.

6. The high weld line strength polypropylene/polycarbonate alloy according to claim 5, wherein the ethylene copolymer is selected from the ethylene copolymer of acrylic acid.

7. The high weld line strength polypropylene/polycarbonate alloy according to claim 1, wherein the polycarbonate is selected from an aromatic polycarbonate, an aliphatic polycarbonate, and an aromatic-aliphatic polycarbonate; the polycarbonate has a weight average molecular weight of 18,000 to 28,000; and in parts by weight, 0 part to 10 parts of a processing aid and/or an additive are further comprised.

8. The high weld line strength polypropylene/polycarbonate alloy according to claim 1, wherein the high weld line strength polypropylene/polycarbonate alloy has weld line strength of 60% or more, and a weld line strength test is according to ASTM D638 standard test.

9. A preparation method of the high weld line strength polypropylene/polycarbonate alloy of claim 7, comprising the following steps: mixing the polycarbonate, polyolefin, the ethylene copolymer compatibilizer, and a processing aid and/or an additive evenly according to a ratio in a high-speed mixer; then adding into a twin-screw extruder, melt mixing at a temperature of 220° C. to 240° C., and then granulating, cooling and drying to obtain the high weld line strength polypropylene/polycarbonate alloy.

10. The preparation method of the high weld line strength polypropylene/polycarbonate alloy according to claim 9, wherein the polypropylene has a melt index of 40 g/10 min to 150 g/10 min under a test condition of 230° C., 2.16 kg; and the ethylene copolymer compatibilizer has a melt index of 0.2 g/10 min to 50 g/10 min under a test condition of 190° C., 2.16 kg.

11. The high weld line strength polypropylene/polycarbonate alloy according to claim 2, wherein the high weld line strength polypropylene/polycarbonate alloy has weld line strength of 60% or more, and a weld line strength test is according to ASTM D638 standard test.

12. The high weld line strength polypropylene/polycarbonate alloy according to claim 3, wherein the high weld line strength polypropylene/polycarbonate alloy has weld line strength of 60% or more, and a weld line strength test is according to ASTM D638 standard test.

13. The high weld line strength polypropylene/polycarbonate alloy according to claim 4, wherein the high weld line strength polypropylene/polycarbonate alloy has weld line strength of 60% or more, and a weld line strength test is according to ASTM D638 standard test.

14. The high weld line strength polypropylene/polycarbonate alloy according to claim 5, wherein the high weld line strength polypropylene/polycarbonate alloy has weld line strength of 60% or more, and a weld line strength test is according to ASTM D638 standard test.

15. The high weld line strength polypropylene/polycarbonate alloy according to claim 6, wherein the high weld line strength polypropylene/polycarbonate alloy has weld line strength of 60% or more, and a weld line strength test is according to ASTM D638 standard test.

16. The high weld line strength polypropylene/polycarbonate alloy according to claim 7, wherein the high weld line strength polypropylene/polycarbonate alloy has weld line strength of 60% or more, and a weld line strength test is according to ASTM D638 standard test.

17. The high weld line strength polypropylene/polycarbonate alloy according to claim 8, wherein the high weld line strength polypropylene/polycarbonate alloy has the weld line strength of 65% or more, and the weld line strength test is according to ASTM D638 standard test.

18. The preparation method of the high weld line strength polypropylene/polycarbonate alloy according to claim 10, wherein the polypropylene has the melt index of 60 g/10 min to 150 g/10 min under the test condition of 230° C., 2.16 kg.

19. The preparation method of the high weld line strength polypropylene/polycarbonate alloy according to claim 10, wherein the ethylene copolymer compatibilizer has the melt index of 0.4 g/10 min to 35 g/10 min under the test condition of 190° C., 2.16 kg.
